(19) United States
(12) Patent Application Publication
(10) Pub. No.: US 2022/0071092 A1
(43) Pub. Date: Mar. 10, 2022

(54) Semi-automated seaweed harvester

(71) Applicants: Christopher Goul, Laguna Beach, CA (US); Ali Badr, Seattle, WA (US)

(72) Inventors: Christopher Goul, Laguna Beach, CA (US); Ali Badr, Seattle, WA (US)

(21) Appl. No.: 17/013,619

(22) Filed: Sep. 6, 2020

(51) Int. Cl. A01D 44/00; A01D 34/03

(52) U.S. Cl. CPC A01D 44/00; A01G 33/00; A01D 34/03

(57) ABSTRACT

Large seaweed farms rely heavily on manual laborers during the planting and harvesting processes. A prevalent cultivation method among large farms involves placing seaweed spores on long ropes suspended beneath the sea surface. When the seaweed has grown to the desired length, laborers manually remove strands from said ropes. The present invention provides a system to automate the harvesting of seaweed from said ropes. The present invention combines propulsion, guidance, and harvesting mechanisms into a single unit cable of autonomously removing seaweed from said ropes.

### CROSS-REFERENCE TO RELATED APPLICATIONS

Not applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### FIELD OF THE INVENTION

The present subject matter relates, in general, to the farming of seaweed. More particularly, the invention relates to a device for harvesting seaweed in an efficient, semi-automated manner.

### BACKGROUND ART

The global demand for seaweed continues to rise due to its widespread use in a variety of industries. Seaweeds are used as a source of human food, for the manufacture of hydrocolloids, fertilizers, and animal feed. Ongoing research proposes to scale up seaweed production to use as biomass for energy generation, or in conjunction with fish farms to increase yields and reduce waste.

Seaweed farming is the practice of cultivating seaweeds, and occurs on a variety of scales. Farms range from being managed by a single family to commercial operations spanning hundreds of acres. While farm layouts and methods of harvesting vary, in general seaweed farming is a very labor intensive activity. Farm planting and harvesting are critical times at which demand for manual labor surges. Conventional farming methods do not address this problem, and often rely on long hours and hiring seasonal workers to meet labor needs. Other proposed methods of using technology to reduce manual labor have not been successfully implemented on a large scale, and commonly require expensive machinery or extensive modification of existing farm layouts in order to be put to use. There still remains a need for a scalable, cost-effective, and efficient technology to mitigate the requirement seaweed farming has on manual labor during harvesting.

### DESCRIPTION OF THE INVENTION

The present invention provides a system for harvesting seaweed that is less reliant on manual labor than current practices. Said invention comprises: a flotation system, a propulsion device, a frame for interacting with the seaweed farm ropes, a cutting mechanism for removing seaweed from said lines, and a storage compartment for holding the harvested seaweed. In one embodiment, a worker places the seaweed harvester at one end of a long rope bearing seaweed. The design of the frame permits it to travel along said rope with limited input from a human operator under the power of its propulsion device. As it travels, the cutting mechanism removes seaweed from the line, which falls into a storage system. At the end of the line, a worker receives the device and the harvested seaweed. In such an embodiment, a limited number of workers are able to quickly and efficiently undertake the harvesting of seaweeds, with no need for significant modification of the farm layout and structure.

Other aspects, embodiments, and features of the invention will be presented in the following detailed description of the invention and the provided figures. It is appreciated that these drawings depict only typical embodiments of the invention and are therefore not to be considered limiting of its scope. The invention will be described and explained with additional specificity and detail with the accompanying drawings. For purposes of clarity, not every component is labelled in every figure. Nor is every component of each embodiment of the invention shown where illustration is not necessary to allow those of ordinary skill in the art to understand the invention.

### BRIEF DESCRIPTION OF THE DRAWINGS

FIG. 1 shows a perspective view of the core seaweed harvesting mechanisms according to the invention.

FIG. 2 shows a side view of the seaweed harvesting apparatus according to the invention.

### DETAILED DESCRIPTION OF THE DRAWINGS

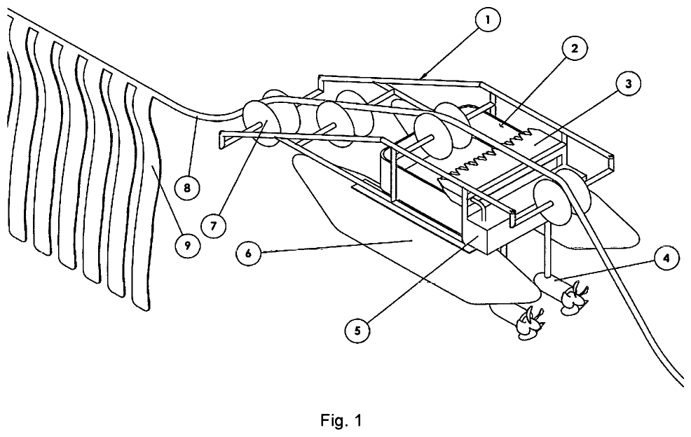

FIG. 1 shows in detail a perspective view of the seaweed harvesting apparatus according to the invention.

The seaweed harvesting apparatus comprises a frame 1 for aligning the farm rope 8 relative to the harvesting apparatus using a series of grooved pulleys 7. In other words, the frame 1 has guiding means 7 for aligning the farm rope 8 and the harvesting apparatus.

The seaweed harvesting apparatus comprises a flotation system 6 for keeping the apparatus afloat and balanced.

The seaweed harvesting apparatus comprises a propulsion device 4 enabling the system to travel along the farm rope 8 at a stable, quick speed. Here, the propulsion device receives power from enclosed batteries 5.

The seaweed harvesting apparatus comprises a cutting mechanism 3 for cutting seaweed from the farm rope 8. Here, the cutting mechanism receives power from enclosed batteries 5.

The seaweed harvesting apparatus comprises a storage system 2 for holding seaweed 9 removed from the farm rope 8 by the cutting mechanism 3.

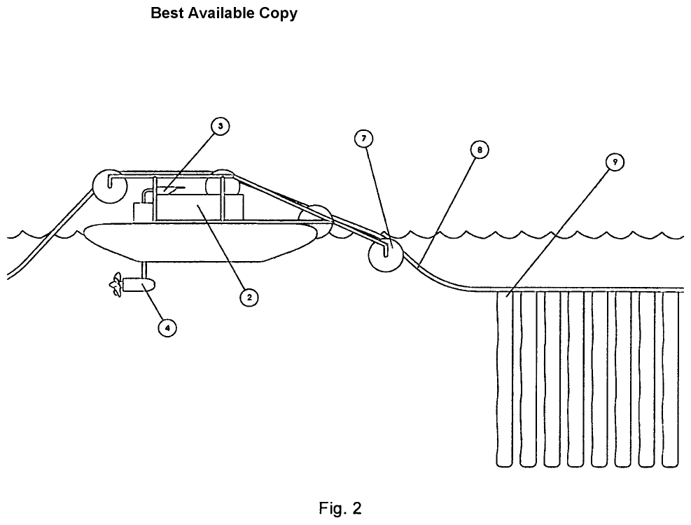

FIG. 2 illustrates a side view of the seaweed harvesting apparatus in relation to the seaweed farm ropes 9. The apparatus travels down the length of the farm rope 8 propelled by motor 4. The grooved pulleys 7 ensure that the farm rope 8, along with attached seaweed 9, pass over the cutting mechanism 3 as the apparatus moves forwards. Seaweed 9 falls into storage system 2 after being trimmed by cutting mechanism 3.

I claim:

1. A seaweed harvesting system for harvesting and storing seaweed comprising:
a. A flotation system to keep the mechanism afloat and balanced while managing the load of carried seaweed
b. A propulsion device enabling the system to travel down the seaweed line at a stable, quick speed
c. A frame that allows easy interaction between the harvesting system and the seaweed farm ropes
d. A cutting mechanism for removing seaweed from said farm ropes
e. A storage compartment for holding the harvested seaweed from said farm ropes

2. The seaweed harvesting system according to claim 1, wherein the system frame comprises guide rails for aligning the farm ropes relative to the harvesting system.

3. The seaweed harvesting system according to claim 1, wherein the cutting device comprises an adjustment mechanism to produce different lengths of trimmed seaweed

4. A vessel comprising a seaweed harvesting system according to all of the preceding claims.
